(19) United States
(12) Patent Application Publication
(10) Pub. No.: US 2026/0303016 A1
(43) Pub. Date: Oct. 1, 2026

(54) SOLAR TRACKER COMMISSIONING

(71) Applicant: ARRAY TECH, INC., Albuquerque, NM (US)

(72) Inventors: Imanol Olazarri, Pamplona (ES); Iñigo Garcia Colomo, Pamplona (ES); Aitor Gomez, Pamplona (ES)

(21) Appl. No.: 19/573,321

(22) Filed: Mar. 20, 2026

Related U.S. Application Data
(60) Provisional application No. 63/777,918, filed on Mar. 26, 2025.

(51) Int. Cl. H02S 50/00; G01C 9/02; G01C 25/00; H02S 20/32; H04L 67/12

(52) U.S. Cl. CPC H02S 50/00; G01C 9/02; G01C 25/00; H04L 67/12; H02S 20/32

(57) ABSTRACT

A method of commissioning a photovoltaic system may include measuring, via an inclinometer, an inclination of a PV module controller. The measured inclination may be compared with a pre-determined inclination for a PV module. The measured inclination may be calibrated to the pre-determined inclination. A method of commissioning a PV system may include providing, via a PV module controller, a network configuration request including a device identifier and a GPS location to a system network controller. A device network configuration may be determined for the PV module controller based on the GPS location and the device network configuration may be associated with the device identifier. The device network configuration may be provided to the PV module controller, and the PV module controller may establish a connection to a network in response to receiving the device network configuration.

### CROSS-REFERENCE TO RELATED APPLICATIONS

This patent application claims priority to and the benefit of U.S. Provisional Patent Application Ser. No. 63/777,918, entitled AUTONOMOUS SOLAR TRACKER COMMISSIONING, filed Mar. 26, 2025, which is incorporated by reference in its entirety.

### FIELD

The present disclosure relates to solar energy production and more particularly to solar tracker commissioning.

### BACKGROUND

Solar power plants are becoming increasingly prevalent as a source of renewable energy. These installations may include numerous photovoltaic (PV) modules arranged in rows to capture solar radiation and convert the solar radiation into energy. To increase energy production, many solar power plants utilize solar tracking systems that adjust the orientation of the PV modules throughout the day to follow the Sun's path across the sky.

PV modules in a solar tracking system may be adjusted to track the Sun's position in the sky through the use of PV module controllers. Because solar tracking systems may be extensive and implement many rows of PV modules, there may be a large amount of PV module controllers in a solar tracking system. Before the solar tracking system may be commissioned and operational, the PV module controllers may need to be calibrated to the PV modules that each PV module controller controls and the PV module controllers may need to be configured so that the PV module controllers may access a network. The process of configuring and calibrating individual PV module controllers distributed across a wide area may be time-consuming and labor-intensive. For example, technicians may need to physically visit each PV module controller to perform various setup tasks.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Commissioning a large-scale solar power plant with solar tracking capabilities may present several challenges. For example, in order to accurately track the Sun's position, each PV module controller may need to obtain the inclination of the PV module. Often PV module controllers come equipped with an inclinometer that may be used to measure the inclination of the PV modules. However, there may be an offset between the inclination of the inclinometer, which may be mounted on a printed circuit board (PCB) within the PV module controller, and the actual inclination of the PV module. Thus, in order for the solar tracking system to be commissioned and to function properly, the inclination measured on the inclinometer may need to be calibrated to the actual inclination of the PV module.

Calibrating this offset for each controller may require significant manual effort and typically involves manual measurements and adjustments. A technician may need to physically visit each PV module controller, and, in many cases, by the time a technician reaches each controller, the PV module may not be horizontal. Thus, the technician may need to measure the inclination of the PV module, compare the inclination of the PV module to the measured inclination of the inclinometer in the PV module controller, and calibrate the inclinometer accordingly. This manual calibration process may require several minutes of technician time to calibrate a single PV module controller.

Another challenge in commissioning solar tracking systems may relate to network configuration. Large solar installations may utilize wireless networks such as Bluetooth or Zigbee or wired networks such as RS-485 to enable communication between the numerous PV module controllers and a centralized control unit such as a system network controller. Manually configuring network parameters for each controller may be an error-prone and time-intensive process.

For example, configuring the network in a solar tracker system may involve a technician physically visiting each PV module controller and associating the location and an identifier of the PV module controller with the network identity of the PV module controller. This association may be necessary for proper system operation and monitoring. However, manually recording location data and correlating the location data with controller identifiers across a vast solar tracking system may be complex and subject to human error. For example, a technician may need to visit each PV module controller individually to obtain the MAC address of the PV module controller so that the network may be configured and the PV module controller may be operational.

These commissioning challenges may significantly impact the deployment timeline and costs for solar tracker systems. The need for extensive manual intervention may limit the rate at which new solar tracker systems may be brought online. Additionally, the potential for human error during manual configuration processes may lead to system inefficiencies or malfunctions that require further time and resources to diagnose and correct.

Accordingly, there exists a need for improved methods and systems for commissioning solar tracking installations that may reduce the reliance on manual processes, minimize on-site labor requirements, and/or accelerate deployment timelines in commissioning a solar tracking system while also maintaining or enhancing system setup accuracy and reliability.

Example embodiments of the present disclosure address problems experienced in conventional photovoltaic (PV) system commissioning, including time-consuming manual configuration of tracker controllers. At least some of the embodiments disclosed herein may address this problem by providing methods for commissioning a PV system. The methods disclosed address the challenges in commissioning large scale PV systems by enabling at least partially autonomous network configuration and/or at least partially autonomous inclination calibration. Traditionally, commissioning PV systems requires manual, time-consuming techniques to calibrate each PV module controller and configure the network of each PV module controller. The methods disclosed streamline the commissioning process through at least partially automated network configuration and/or at least partially automated inclination calibration.

A method for commissioning a PV system may include providing, via a PV module controller, a network configuration request to a system network controller. The network configuration request may include a device identifier identifying the PV module controller and a GPS location of the PV module controller. Based on the GPS location, a device network configuration may be determined for the PV module controller. The device network configuration may be associated with the device identifier and sent to the PV module controller. In response to receiving the device network configuration, a connection may be established between the PV module controller and a network. As a result, the PV module may be configured to connect to the network automatically without a technician physically visiting each PV module controller.

In some embodiments, the method for commissioning a PV system may include correlating the GPS location of the PV module controller with a planned GPS location. The planned GPS location may be included in a system network configuration, and the determination of the device network configuration may be based on the correlation of the GPS location with the planned GPS location. In some embodiments, the system network configuration may be stored in the system network controller. In some embodiments, the system network configuration may include the device network configuration of the PV module controller.

In some embodiments, the method may further include powering on the PV module controller. In some embodiments, the PV module controller may provide the network configuration request to the system network controller in response to being powered on.

In some embodiments, the device network configuration may include a network identifier and/or a node identifier. In these and other embodiments, the network identifier and/or the node identifier may be associated with a planned GPS location of the PV module controller.

Another method of commissioning the PV module controller may include calibrating the PV module controller. Calibrating the PV module controller may include measuring an inclination of the PV module controller via an inclinometer included in the PV module controller. The measured inclination may be compared with a pre-determined inclination for a PV module. The measured inclination may then be calibrated to the pre-determined inclination for the PV module. As a result, the inclination of the PV module controller may be calibrated to the PV module without a technician physically visiting each PV module controller.

In some embodiments, the method of commissioning the PV module controller may further include powering on the PV module controller, and the PV module controller may calibrate the measured inclination of the PV module controller to the pre-determined inclination of the PV module in response to being powered on.

In some embodiments, the pre-determined inclination for the PV module may be about zero degrees. In some embodiments, the PV module controller may include a printed circuit board (PCB), and the measured inclination of the PV module controller may be the inclination of the PCB.

Overall, at least some of the embodiments disclosed may reduce the need for manual configuration of each PV module controller in a PV system by autonomously configuring each PV module controller such that the PV module controller may connect to a network and/or by autonomously calibrating the inclination measured at the inclinometer with the actual orientation of the PV module. This process may save several minutes of technician time per PV module controller, and because there may be many different PV module controllers in a PV system, this process may result in solar tracking systems being operational days, weeks, or even months ahead of schedule compared to manual methods. While the commissioning of PV module controllers and/or PV systems is described throughout the disclosure as being “autonomous,” it will be appreciated that portions of the commissioning process may still require manual intervention such that the commissioning process may not be entirely autonomous.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example photovoltaic (PV) system including a PV module controller having a Global Positioning System (GPS) and an inclinometer;

FIG. 2 illustrates an example operational workflow of at least partially autonomously commissioning a PV system;

FIG. 3 illustrates an example PV system configured to perform at least partially autonomous commissioning;

FIGS. 4A and 4B illustrate another example PV system configured to perform at least partially autonomous commissioning;

FIG. 5 illustrates another example PV system configured to perform at least partially autonomous commissioning;

FIG. 6 is a flowchart of an example method of commissioning a PV system;

FIG. 7 is a flowchart of an example method of commissioning a PV system;

FIG. 8 is a flowchart of an example method of commissioning a PV system; and

FIG. 9 illustrates an example computer system that may be employed in an example photovoltaic system.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

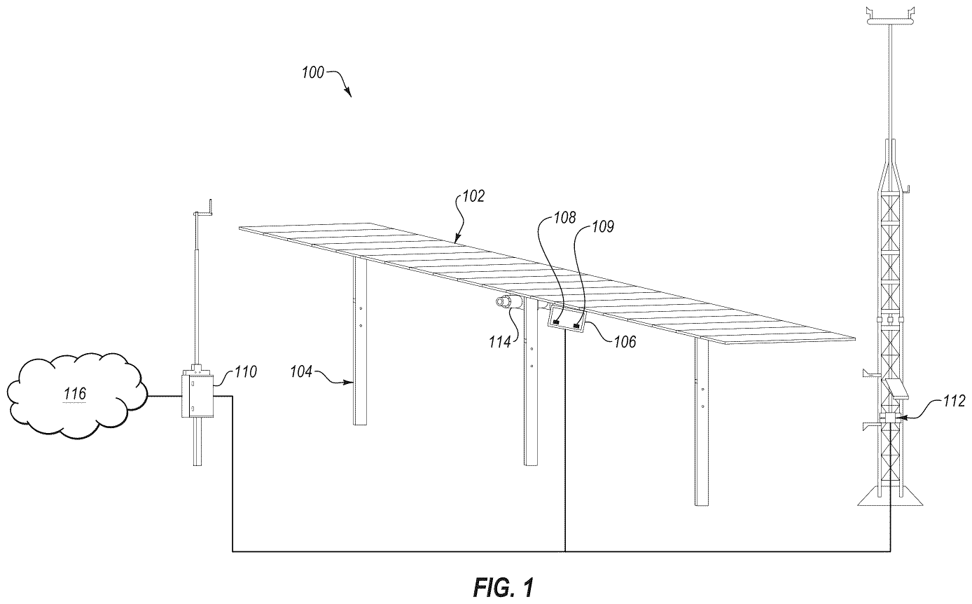

FIG. 1 illustrates an example photovoltaic (PV) system 100. The PV system 100 may include a PV module 102. The PV system 100 may also include a support column (or pile) 104, and a torque tube (not shown). The PV module 102 may be coupled to the torque tube such that the rotation of the torque tube may be translated to the PV module 102 enabling the PV module 102 to track the position of the Sun in the sky throughout the day. For example, as the Sun rises and early in the day, the PV module 102 may be rotated by a torque tube such that the PV module 102 may be facing an easterly direction, around mid-day the PV module 102 may be rotated by the torque tube such that the PV module 102 may be substantially horizontal, and as the Sun sets and later in the day, the PV module 102 may be rotated by a torque tube such that the PV module 102 may be facing a westerly direction. Additionally or alternatively, the PV module 102 may be rotated by a torque tube in response to weather events such as hailstorms or snowstorms, for maintenance purposes, and/or in response to other factors other than to track the position of the Sun. The support columns 104 may be driven into the ground and may provide vertical support for the PV module 102 and the torque tube. The torque tube may provide horizontal support to the PV module 102, and the torque tube may be rotated by a motor 114.

The PV system 100 may further include a system network controller 110 and a PV module controller 106. The system network controller 110 may be communicatively coupled with the PV module controller 106 such that the PV module controller 106 may send data to and/or receive data from the system network controller 110. The PV module controller 106 may include a global positioning system (GPS) 108 and/or an inclinometer 109. The GPS 108 may include a standard GPS (GPS L1), a differential GPS (DGPS), a real-time kinematic (RTK) GPS, a multi-constellation GPS, an assisted GPS (A-GPS), and/or other suitable global positioning system capable of providing geographic location data. The inclinometer 109 may be a digital inclinometer, a micro-electro-mechanical system (MEMS) inclinometer, a capacitive inclinometer, or any other inclinometer suitable for measuring the inclination of the PV module controller 106. The PV module controller 106 may be coupled with the PV module 102 such that, as the PV module 102 rotates to track the position of the Sun, the PV module controller 106 rotates with the PV module 102. Thus, the inclination measured by the inclinometer 109 may change as the PV module 102 rotates to track the position of the Sun. In some embodiments, the inclinometer 109 may be included on a printed circuit board (PCB) of the PV module controller 106.

In some embodiments, the PV system 100 may further include a weather controller 112, which may be configured to collect weather data (e.g., solar data, precipitation data, wind data, or other weather data). In these and other embodiments, the weather controller 112 may be communicatively coupled with the system network controller 110 and/or the PV module controller 106 such that the weather controller 112 may send data to and/or receive data from the system network controller 110 and/or the PV module controller 106.

In an example operation of the PV system 100, the weather controller 112 may collect weather data such as solar data indicating the position of the Sun in the sky. The weather controller 112 may send the weather data to the system network controller 110, which may route the weather data to the PV module controller 106. The PV module controller 106 may cause the PV module 102 to rotate based on the weather data. For example, the PV module controller 106 may rotate the PV module 102 based on weather data indicating the Sun's position in the sky. For instance, the PV module controller 106 may utilize an solar algorithm to determine the Sun's position in the sky and may cause the motor 114 to rotate the torque tube coupled to the PV module 102, which may align the PV module 102 with the position of the Sun.

Prior to the physical operation of the PV system 100, the PV module controller 106 in the PV system 100 may need to be commissioned. Typically, to commission the PV module controller 106, a technician had to physically visit the PV module controller 106 to perform the network configuration for the PV module controller 106 such that the PV module controller 106 may cause the PV module 102 to rotate to track the position of the Sun. Additionally, the inclinometer 109 may not be perfectly aligned with the inclination of the PV module 102, and so the technician may need to calibrate the inclinometer 109 such that the inclination measured by the inclinometer 109 may accurately represent the inclination of the PV module 102. The PV system 100 may include many different PV module controllers 106 so the commissioning process may take days, weeks, and/or months to complete. In at least some of the embodiments disclosed, at least a portion of this commissioning process may be performed autonomously.

For example, in some embodiments, the system network controller 110 may be coupled to a network 116. The network 116 may be any wired or wireless network, or combination of multiple networks, configured to send and receive communications between systems and devices. In some embodiments, the network 116 may include a Personal Area Network (PAN), a Local Area Network (LAN), a Metropolitan Area Network (MAN), a Wide Area Network (WAN), a Storage Area Network (SAN), a cellular network, the Internet, or some combination thereof. A system network configuration may be delivered to the system network controller 110 via the network 116. For example, the system network configuration may be delivered to the system network controller 110 from a cloud platform having the system network configuration. In some embodiments, the system network configuration may be stored in the system network controller 110.

The system network configuration may be a network plan of the PV system 100. The system network configuration may include a device network configuration for the PV module controller 106. In some embodiments, the device network configuration may include a network identifier for the PV module controller 106 and/or a node identifier for the PV module controller 106. In some embodiments, the network identifier may be a personal area network (PAN) identifier. In some embodiments, the node identifier may be a slave identifier, a device address, a Bluetooth address, or any other unique identifier used to distinguish nodes in a network.

For example, in embodiments where a Zigbee network is being configured, the device network configuration may include a PAN identifier and a slave identifier. In another example, in embodiments where an RS-485 network is being configured, the device network configuration may include a slave identifier such as a Modbus address. In some embodiments, the system network configuration may include a planned GPS location. In some embodiments, the planned GPS coordinates may be associated with the device network configuration of the PV module controller 106. For example, the planned GPS coordinates may be associated with a network identifier (e.g., a PAN ID) and/or a node identifier (e.g., a slave identifier) of the PV module controller 106.

In some embodiments, the PV module controller 106 may be configured to connect to the closest system network controller 110 in the PV system 100 when the PV module controller 106 is installed and powered on. For example, the PV module controller 106 may automatically connect to the system network controller 110, which may be the closest system network controller 110 to the PV module controller 106.

The PV module controller 106 may send a network configuration request to the system network controller 110. In some embodiments, the PV module controller 106 may send the network configuration request to the system network controller 110 in response to being powered on. The network configuration request may include a device identifier of the PV module controller 106 and a GPS location of the PV module controller 106. The GPS location may be determined by the GPS 108. The device identifier may include a hardware identifier such as a media access control (MAC) address and/or a serial number. In some embodiments, the MAC address may be a Bluetooth MAC address or a Zigbee MAC address.

The system network controller 110 may determine the device network configuration for the PV module controller 106 based on the GPS location of the PV module controller 106. For example, the system network controller 110 may correlate the GPS location with the planned GPS location of the PV module controller 106 in the system network configuration. The system network controller 110 may determine the device network configuration for the PV module controller 106 based on the correlation of the GPS location of the PV module controller 106 with the planned GPS location of the PV module controller 106. In some embodiments, the GPS location of the PV module controller 106 may be correlated with the planned GPS location despite the GPS location not matching the planned GPS location exactly. For example, the planned GPS location may be correlated with the GPS location when the GPS location is within a tolerance of the planned GPS location. For instance, the planned GPS location may be correlated with the GPS location if the GPS location is within a tolerance of between about 0 feet and about 10 feet of the planned GPS location. Thus, the system network controller 110 may utilize the GPS location of the PV module controller 106 to determine the device network configuration for the PV module controller 106.

The system network controller 110 may associate the device network configuration of the PV module controller 106 with the device identifier of the PV module controller 106. For example, a PAN identifier and a slave identifier may be associated with a MAC address identifying the PV module controller 106.

The system network controller 110 may provide the device network configuration to the PV module controller 106. For example, the system network controller 110 may provide a network identifier and/or a node identifier to the PV module controller 106. The network identifier may be an identifier of a network to which the PV module controller 106 may connect, and the node identifier may be a unique identifier of the PV module controller 106 within a network. For example, the network identifier may be a PAN identifier of a Zigbee network, and the node identifier may be a slave identifier of the PV module controller 106.

Thus, providing the device network configuration to the PV module controller 106 may allow the PV module controller 106 to establish a connection to a network in response to receiving the device network configuration. The network may be a different network than the network 116. For example, the network may be a network of one or more system network controllers 110, one or more PV module controllers 106, and/or one or more weather controllers 112. Additionally or alternatively, the network may be the network 116. In some embodiments, the PV module controller 106 may establish a connection with a wireless network such as a Zigbee network, a Bluetooth network, a Z-wave network, a Thread network, or other wireless networks depending on the device network configuration. For example, one or more PV module controllers 106 may be connected to the system network controller 110 via a Zigbee network having a particular PAN identifier, and each of the one or more PV module controllers 106 may have a unique slave identifier in the Zigbee network that may allow the system network controller 110 to route data to specific PV module controllers 106. In some embodiments, the PV module controller 106 may establish a connection with a wired network such as a coaxial cable network, a fiber optic cable network, a category 5/5/e/6 network, an RS-485 (Modbus) network, an RS-232 network, or other wired networks, depending on the device network configuration. For example, one or more PV module controllers 106 may be connected to the system network controller 110 via an RS-485 network, and each of the one or more PV module controllers 106 may have a unique Modbus address that may allow the system network controller 110 to route data to specific PV module controllers 106.

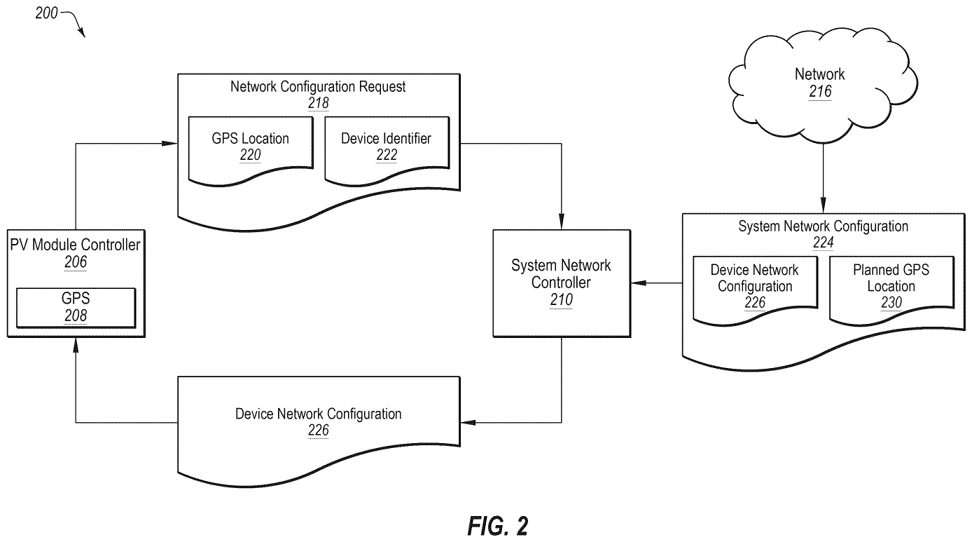

As a result, the network configuration of the PV module controller 106 may be performed autonomously without sending a technician to the PV module controller 106 for configuration. In addition, the autonomous network configuration of the PV module controller 106 may reduce the time of the commissioning process and enable the PV system 100 to be operational days, weeks, or even months faster than the PV system 100 otherwise would be utilizing a manual process of network configuration. The network configuration of the PV module controller 106 is described in more detail with reference to FIGS. 2-4B, FIG. 6, and FIG. 8.

In some embodiments, the calibration of the inclinometer 109 may be performed autonomously. The inclinometer 109 may be included in the PV module controller 106 and may measure an inclination of the PV module controller 106. For example, the PV module controller 106 may include a printed circuit board (PCB), which may include the inclinometer 109, and the measured inclination may be the inclination of the PCB. The PV module controller 106 may be installed below the PV module 102 and there may be one or more components—such as the torque tube and/or clamps coupling the torque tube to the PV module 102—separating the PV module controller 106 and the PV module 102. Each of the components separating the PV module controller 106 and the PV module 102 and the PV module controller 106 may be slightly misaligned with the PV module 102 as a result of installation, which may cause the inclination measured by the inclinometer 109 in the PV module controller 106 to be different than the inclination of the PV module 102.

The PV module 102 may be installed at a pre-determined inclination. For example, the PV module 102 may be installed at about zero degrees of inclination, which may be the pre-determined inclination. The PV module controller 106 may compare the inclination measured by the inclinometer 109 with the pre-determined inclination of the PV module 102.

The PV module controller 106 may calibrate the measured inclination of the PV module controller 106 to the pre-determined inclination for the PV module 102. For example, the measured inclination of the PV module controller 106 may be different than the pre-determined inclination for the PV module 102, and the PV module controller 106 may calibrate the measured inclination to the pre-determined inclination. For instance, the pre-determined inclination may be zero degrees, the measured inclination may be non-zero, and the PV module controller 106 may calibrate the measured inclination of the inclinometer 109 to be zero such that the measured inclination matches the pre-determined inclination of the PV module 102. In some embodiments, the PV module controller 106 may calibrate the measured inclination of the PV module controller 106 to the pre-determined inclination of the PV module 102 in response to being powered on.

As a result, the calibration of the inclinometer 109 may be performed autonomously without sending a technician to the PV module controller 106 for calibration. In addition, the autonomous calibration of the inclinometer 109 may reduce the time of the commissioning process and enable the PV system 100 to be operational days, weeks, or even months faster than the PV system 100 otherwise would be utilizing a manual process of calibration.

Modifications, additions, or omissions may be made to the PV system 100 without departing from the scope of the present disclosure. For example, multiple PV modules 102, multiple support columns 104, and/or multiple motors 114 may be used in the PV system 100. Furthermore, the PV system 100 may include multiple PV module controllers 106 and/or multiple system network controllers 110. In some embodiments, multiple weather controllers 112 may be included.

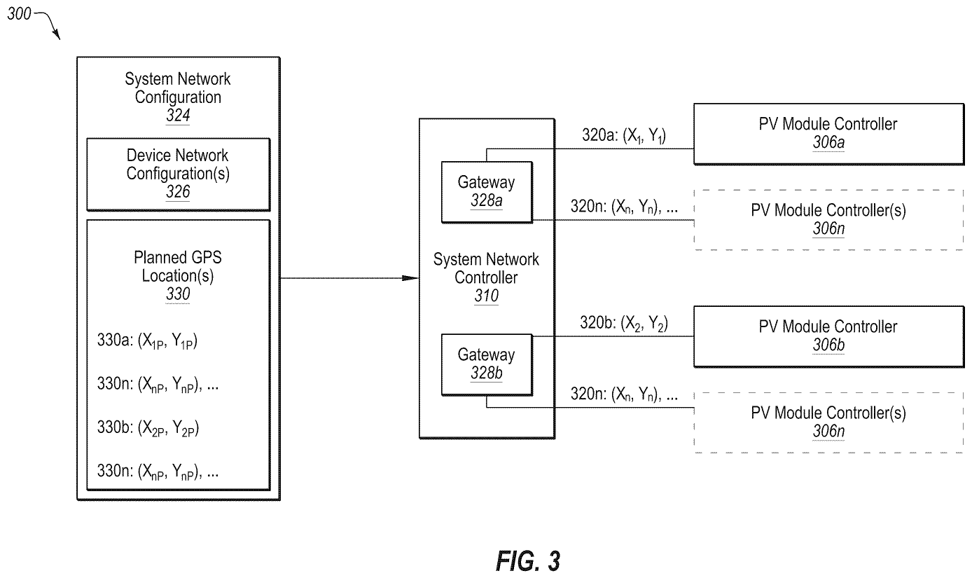

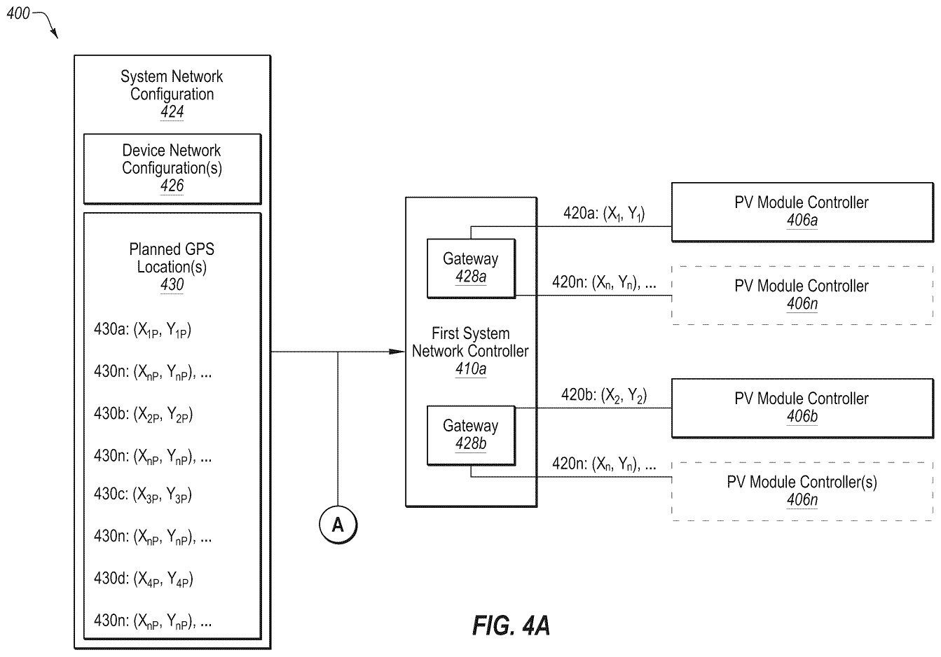

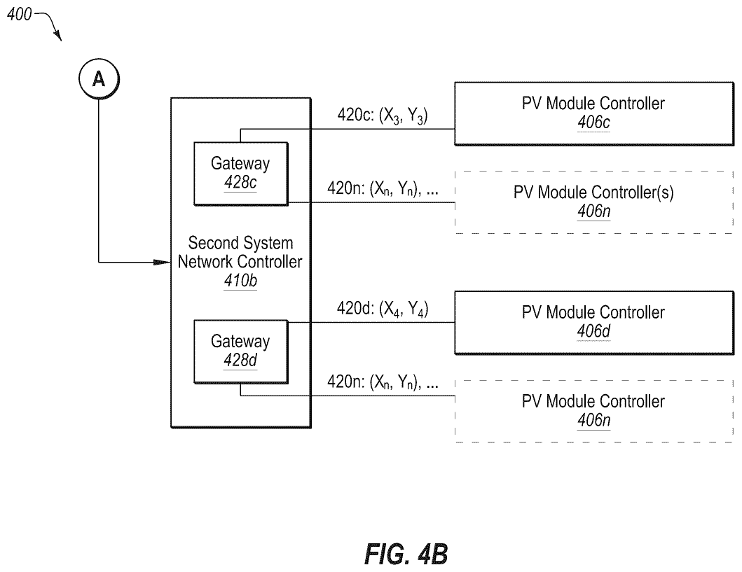

The system network controller 110, the PV module controller 106, and/or the weather controller 112 may be communicatively coupled utilizing a wireless communication protocol (e.g., Bluetooth, Zigbee, thread connection, Z-wave, or other similar wireless communication protocols) or a wired communication protocol (e.g., coaxial cable, fiber optic cable, a category 5/5/e/6 network cable, RS-485 (Modbus), RS-232, or other similar wired communication protocols), depending on the system network configuration of the PV system 100 and/or the device network configuration of the PV module controller 106. For example, and as described in more detail with reference to FIG. 2, FIG. 3, and FIGS. 4A and 4B the PV module controllers 106 may be communicatively coupled to the system network controller 110 via Zigbee or via RS-485. In another example, the weather controller 112 may be communicatively coupled with the system network controller 110, and/or the PV module controllers 106 via Zigbee or via RS-485.

In some embodiments, the weather controller 112 may be omitted from the PV system 100. In some embodiments, the network 116 may be omitted and/or the system network configuration and the device network configuration may be stored in the system network controller 110.

Furthermore, the components illustrated in FIG. 1 and described with reference to FIG. 1 may be similar to, have similar features as, or perform similar functions as similarly named components described throughout this disclosure. For example, the PV module controller 106 may be similar to the PV module controllers described throughout this disclosure and/or the system network controller 110 may be similar to the system network controllers described throughout this disclosure.

FIG. 2 illustrates an example operational workflow 200 that may be implemented, for example, in the PV systems described throughout this disclosure. The operational workflow 200 may include a PV module controller 206 communicatively coupled with a system network controller 210. The PV module controller 206 may include a GPS 208. The system network controller 210 may be communicatively coupled with a network 216.

The PV module controller 206 may provide a network configuration request 218 to the system network controller 210. In some embodiments, the PV module controller 206 may provide the network configuration request 218 to the system network controller 210 in response to being powered on. The network configuration request 218 may include a GPS location 220 and/or a device identifier 222. The GPS location 220 may be a geographical location of the PV module controller 206 in a PV system such as the PV system 100 described with respect to FIG. 1. The GPS location 220 may be determined by the GPS 208. The device identifier 222 may include a hardware identifier such as a media access control (MAC) address and/or a serial number. In some embodiments, the MAC address may be a Bluetooth MAC address or a Zigbee MAC address.

The network 216 may provide a system network configuration 224 to the system network controller 210. The system network configuration 224 may be a network plan of a PV system such as the PV system 100 of FIG. 1. In some embodiments, the system network configuration 224 may include a planned GPS location 230 of the PV module controller 206. The planned GPS location 230 may be a planned geographical installation location of the PV module controller 206 in a PV system such as the PV system 100 described with reference to FIG. 1.

In some embodiments, the system network configuration 224 may include a device network configuration 226. The device network configuration 226 may be the network configuration for the PV module controller 206. The device network configuration 226 may include the settings and/or parameters that may affect how the PV module controller 206 communicates within a network such that the PV module controller 206 may send data to and/or receive data from the system network controller 210. In some embodiments, the device network configuration 226 may include a network identifier for the PV module controller 206 and/or a node identifier for the PV module controller 206. In some embodiments, the network identifier may be a personal area network (PAN) identifier. In some embodiments, the node identifier may be a slave identifier, a device address, a Bluetooth address, or any other unique identifier used to distinguish nodes in a network. For example, in embodiments where a Zigbee network is being configured, the device network configuration 226 may include a PAN identifier and a slave identifier. In another example, in embodiments where an RS-485 network is being configured, the device network configuration 226 may include a slave identifier such as a Modbus address. In some embodiments, the planned GPS location 230 may be associated with the device network configuration 226. For example, the planned GPS location 230 may be associated with a network identifier (e.g., a PAN ID) and/or a node identifier (e.g., a slave identifier) of the PV module controller 206.

The system network controller 210 may determine a device network configuration 226 based on the GPS location 220 of the PV module controller 206. In some embodiments, the system network controller 210 may correlate the GPS location 220 with the planned GPS location 230 in the system network configuration 224, and the system network controller 210 may determine the device network configuration 226 for the PV module controller 206 based on the correlation of the GPS location 220 with the planned GPS location 230 in the system network configuration 224. For example, the system network controller 210 may determine that the GPS location 220 of the PV module controller 206 matches or is within a tolerance of the planned GPS location 230 of the PV module controller 206, and the system network controller 210 may determine that the device network configuration 226, which may be associated with the planned GPS location 230, may be the device network configuration 226 of the PV module controller 206. For instance, the planned GPS location 230 may be correlated with the GPS location 220 when the GPS location 220 is within a tolerance between about 0 feet and about 10 feet of the planned GPS location 230. Thus, the system network controller 210 may utilize the GPS location 220 of the PV module controller 206 to determine the device network configuration 226 for the PV module controller 206.

The system network controller 210 may associate the device network configuration 226 of the PV module controller 206 with the device identifier 222 of the PV module controller 206. For example, a PAN identifier and a slave identifier may be associated with a MAC address identifying the PV module controller 206.

The system network controller 210 may provide the device network configuration 226 to the PV module controller 206. For example, the system network controller 210 may provide a network identifier and/or a node identifier to the PV module controller 206. The network identifier may be an identifier of a network to which the PV module controller 206 may connect, and the node identifier may be a unique identifier of the PV module controller 206 within a network. For example, the network identifier may be a PAN identifier of a Zigbee network and the node identifier may be a slave identifier of the PV module controller 206.

Thus, providing the device network configuration 226 to the PV module controller 206 may allow the PV module controller 206 to establish a connection to a network in response to receiving the device network configuration 226. The network may be a different network than the network 216. For example, the network may be a network of one or more system network controllers 210, one or more PV module controllers 206, and/or one or more weather controllers (not shown). Additionally or alternatively, the network may be the network 216.

In some embodiments, the PV module controller 206 may establish a connection with a wireless network such as a Zigbee network, a Bluetooth network, a Z-wave network, a Thread network, or other wireless networks depending on the device network configuration 226. For example, one or more PV module controllers 206 may be connected to the system network controller 210 via a Zigbee network having a particular PAN identifier, and each of the one or more PV module controllers 206 may have a unique slave identifier in the Zigbee network that may allow the system network controller 210 to route data to specific PV module controllers 206.

In some embodiments, the PV module controller 106 may establish a connection with a wired network such as a coaxial cable network, a fiber optic cable network, a category 5/5/e/6 network, an RS-485 (Modbus) network, an RS-232 network, or other wired networks, depending on the device network configuration 226. For example, one or more PV module controllers 206 may be connected to the system network controller 210 via an RS-485 network, and each of the one or more PV module controllers 206 may have a unique Modbus address that may allow the system network controller 210 to route data to specific PV module controllers 206.

As a result, the operational workflow 200 may allow the network configuration of the PV module controller 206 to be performed autonomously without sending a technician to the PV module controller 206 for configuration. In addition, the autonomous network configuration of the PV module controller 206 may reduce the time spent on commissioning each PV module controller 206 in a PV system such as the PV system 100 described with reference to FIG. 1. The autonomous network configuration of the PV module controller 206 may enable the PV system to be operational days, weeks, or even months faster than the PV system otherwise would be utilizing a manual process of network configuration.

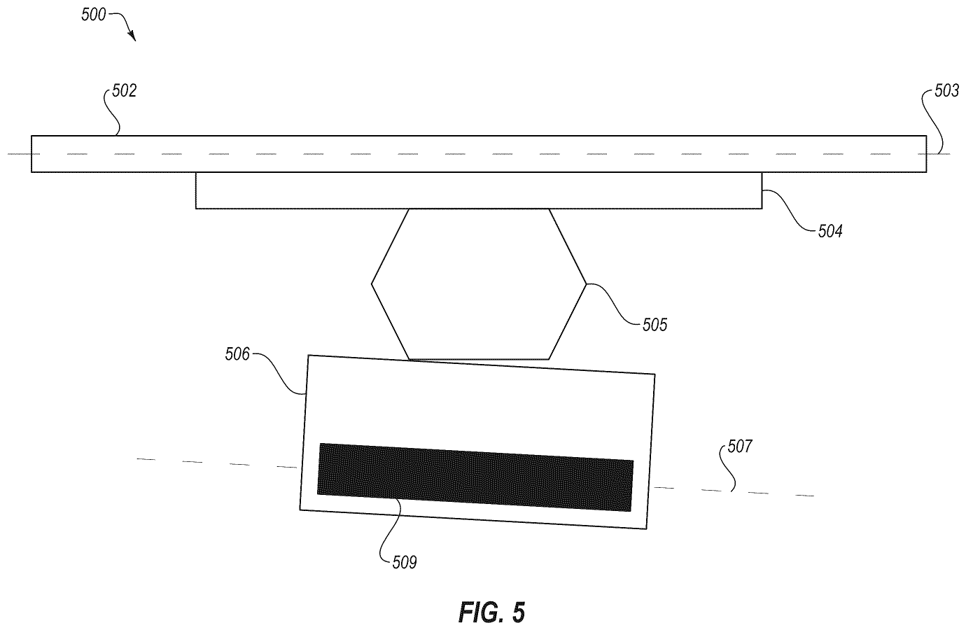

Modifications, additions, or omissions may be made to the operational workflow 200 without departing from the scope of the present disclosure. For example, the operational workflow 200 may include multiple PV module controllers 206 and/or multiple system network controllers 210. For instance, the operational workflow 200 may be implemented in the PV system 100 of FIG. 1, the PV system 300 of FIG. 3, and/or the PV system 400 of FIGS. 4A and 4B. In these and other embodiments, multiple PV module controllers 206 may be communicatively coupled with a single system network controller 210. In some embodiments, the PV module controller 206 may include an inclinometer such as the inclinometer 109 described with respect to FIG. 1. In these and other embodiments, the PV module controller 206 may automatically calibrate the inclination measured by the inclinometer with the inclination of a PV module. This is explained in further detail with reference to FIG. 5.

The system network controller 210 and the PV module controller 206 may be communicatively coupled utilizing a wireless communication protocol (e.g., Bluetooth, Zigbee, thread connection, Z-wave, or other similar wireless communication protocols) or a wired communication protocol (e.g., coaxial cable, fiber optic cable, a category 5/5/e/6 network cable, RS-485 (Modbus), RS-232, or other similar wired communication protocols), depending on the system network configuration 224 and/or the device network configuration 226 of the PV module controller 206. For example, and as described in more detail with reference FIG. 3 and FIGS. 4A and 4B, the PV module controller 206 may be communicatively coupled to the system network controller 210 via Zigbee or via RS-485. In some embodiments, the network 216 may be omitted and the system network configuration 224 and the device network configuration 226 may be stored in the system network controller 210.

Furthermore, the components illustrated in FIG. 2 and described with reference to FIG. 2 may be similar to, have similar features as, or perform similar functions as similarly named components described throughout this disclosure. For example, the PV module controller 206 may be similar to the PV module controllers described throughout this disclosure and/or the system network controllers 210 may be similar to the system network controllers described throughout this disclosure.

FIG. 3 illustrates an example PV system 300 configured to perform at least partially autonomous commissioning. The PV system 300 may include one or more PV module controllers 306 and a system network controller 310. The one or more PV module controllers 306 may include a GPS (not shown) such as the GPSs described throughout this disclosure. The one or more PV module controllers 306 may be communicatively coupled with the system network controller 310.

In some embodiments, the system network controller 310 may include one or more gateways 328. The gateways 328 may communicatively couple one or more of the PV module controllers 306 to the system network controller 310. For example, a first PV module controller 306a may be communicatively coupled with a first gateway 328a, and a second PV module controller 306b may be communicatively coupled with a second gateway 328b. In some embodiments, multiple PV module controllers 306 may be communicatively coupled to a single gateway. For example, as illustrated in FIG. 3, one or more additional PV module controllers 306n may be communicatively coupled to the first gateway 328a and/or one or more additional PV module controllers 306n may be communicatively coupled to the second gateway 328b. The gateways 328 may be an intermediary or bridge enabling communication between two or more different communication protocols, network nodes, or network systems. For example, the gateways 328 may allow the system network controller 310 to communicate between different protocols. For instance, the system network controller 310 may communicate with the PV module controllers 306 via Zigbee but may communicate to other system components through other wireless communication protocols or a wired communication protocol.

In some embodiments, a system network configuration 324 may be provided to the system network controller 310. The system network configuration 324 may be a network plan of the PV system 300. In some embodiments, the system network configuration 324 may be provided by a network such as the network 116 described with reference to FIG. 1. In some embodiments, the system network configuration 324 may be stored in the system network controller 310.

In some embodiments, one or more device network configurations 326 may be provided to the system network controller 310. For example, a device network configuration 326 may be provided to the system network controller 310 for the first PV module controller 306a, and another device network configuration 326 may be provided to the system network controller 310 for the second PV module controller 306b. In some embodiments, the device network configurations 326 may be provided by a network such as the network 116 described with reference to FIG. 1. In some embodiments, the device network configurations 326 may be at least partially unique to each of the PV module controllers 306 in the PV system 300. In some embodiments, the one or more device network configurations 326 may be stored in the system network controller 310. In some embodiments, the device network configurations 326 may be included in the system network configuration 324. In some embodiments, the device network configurations 326 may be provided separately from the system network configuration 324.

In some embodiments, the device network configurations 326 may include a network identifier for each PV module controller 306 and/or a node identifier for each PV module controller 306. In some embodiments, the network identifier may be a personal area network (PAN) identifier. In some embodiments, the node identifier may be a slave identifier, a device address, a Bluetooth address, or any other unique identifier used to distinguish nodes in a network. For example, in embodiments where a Zigbee network is being configured, the device network configuration 326 may include a PAN identifier and a slave identifier for each of the PV module controllers 306. In another example, in embodiments where an RS-485 network is being configured, the device network configuration 326 may include a slave identifier such as a Modbus address for each of the PV module controllers 306.

In some embodiments, the network identifiers in the device network configurations 326 may be the same for at least some of the PV module controllers 306. For example, the first PV module controller 306a may be communicatively coupled to the first gateway 328a via a Zigbee network, and one or more additional PV module controllers 306n may be communicatively coupled to the first gateway 328a via the Zigbee network. In these and other embodiments, the first PV module controller 306a and the additional PV module controllers 306n communicatively coupled to the first gateway 328a may each have a device network configuration 326 having the same PAN identifier identifying the Zigbee network. In these and other embodiments, the PV module controllers 306 may have different node identifiers. For example, the first PV module controller 306a may have a different node identifier than each of the additional PV module controllers 306n coupled to the first gateway 328a. For instance, in embodiments where a Zigbee network is implemented, each of the PV module controllers 306 communicatively coupled to the first gateway 328a may have a different slave identifier. In another example, in embodiments where an RS-485 network is implemented, each of the PV module controllers 306 coupled to the first gateway 328a may have a different Modbus address.

In some embodiments, the network identifiers in the device network configuration 326 may be different for at least some of the PV module controllers 306. For example, the first PV module controller 306a may be communicatively coupled to the first gateway 328a via a first Zigbee network, the second PV module controller 306b may be communicatively coupled to the second gateway 328b via a second Zigbee network, and the first PV module controller 306a and the second PV module controller 306b may have different PAN identifiers. For instance, the first Zigbee network may have a first PAN identifier and the second Zigbee network may have a second PAN identifier. Thus, in the previous example, each of the PV module controllers 306 with the first PAN identifier may be communicatively coupled with the system network controller 310 via the first gateway 328a, and each of the PV module controllers 306 with the second PAN identifier may be communicatively coupled with the system network controller 310 via the second gateway 328b.

In some embodiments, a planned GPS location 330 for each of the PV module controllers 306 may be provided to the system network controller 310. For example, planned GPS locations 330 may be provided to the system network controller 310 by a network such as the network 116 described with reference to FIG. 1. For instance, the first PV module controller 306a may have a first planned GPS location 330a (X_{1P}, Y_{1P}), the second PV module controller 306b may have a second planned GPS location 330b (X_{2P}, Y_{2P}), and the one or more additional PV module controllers 306n communicatively coupled to the gateways 328 may each have a planned GPS location 330n (Xₙₚ, Yₙₚ). In some embodiments, the device network configuration 326 of each PV module controller 306 may be associated with a corresponding planned GPS location 330. For example, the device network configuration 326 of the first PV module controller 306a may be associated with the first planned GPS location 330a (X_{1P}, Y_{1P}) of the first PV module controller 306a, and the device network configuration 326 of the second PV module controller 306b may be associated with the second planned GPS location 330b (X_{2P}, Y_{2P}) of the second PV module controller 306b. In some embodiments, the network identifier and/or the node identifier of each PV module controller 306 may be associated with a corresponding planned GPS location 330 of each PV module controller 306. For instance, the device network configuration 326 of the first PV module controller 306a may include a first PAN identifier and a first slave identifier, and the device network configuration 326 of the first PV module controller 306a may be associated with the first planned GPS location 330a (X_{1P}, Y_{1P}) of the first PV module controller 306a.

As described previously, each of the PV module controllers 306 may include a GPS such as the GPS 108 described with reference to FIG. 1. The PV module controllers 306 may each provide a network configuration request to the system network controller 310. For example, the first PV module controller 306a may provide a first network configuration request to the system network controller 310, and the second PV module controller 306b may provide a second network configuration request to the system network controller 310. In some embodiments, the PV module controllers 306 may provide the network configuration request to the system network controller 310 when the PV module controllers 306 are powered on.

The network configuration request may include a device identifier and a GPS location 320 determined by the GPS. The device identifier may include a hardware identifier such as a media access control (MAC) address and/or a serial number. In some embodiments, the MAC address may be a Bluetooth MAC address or a Zigbee MAC address. The GPS location 320 may provide coordinates representing the physical location of the PV module controllers 306 in the PV system 300. For example, as illustrated in FIG. 3, the first PV module controller 306a may provide a first GPS location 320a (X₁, Y₁), the second PV module controller 306b may provide a second GPS location 320b (X₂, Y₂), and/or the additional PV module controllers 306n communicatively coupled to the gateways 328 may each provide a GPS location 320n (Xₙ, Yₙ) to the system network controller 310.

The system network controller 310 may determine the device network configuration 326 for each of the PV module controllers 306 sending a network configuration request to the system network controller 310 based on the GPS location 320 the system network controller 310 receives from the PV module controllers 306. In some embodiments, the system network controller 310 may correlate the GPS location 320 of the PV module controllers 306 with the planned GPS location 330 of the PV module controllers 306. In these and other embodiments, the system network controller 310 may determine the device network configuration 326 for the PV module controllers 306 based on the correlation of the GPS locations 320 with the planned GPS locations 330. For example, the system network controller 310 may determine that the first GPS location 320a (X₁, Y₁) matches or may be within a tolerance of the first planned GPS location 330a (X₁ₚ, Y_{1P}) of the first PV module controller 306a and based on this correlation, the system network controller 310 may determine the device network configuration 326 for the first PV module controller 306a. For instance, the device network configuration 326 of the first PV module controller 306a may be associated with the first planned GPS location 330a. When the system network controller 310 receives a network configuration request having the first GPS location 320a and the first GPS location 320a matches or is within a tolerance of the first planned GPS location 330a, the system network controller 310 may determine that the device network configuration 326 associated with the first planned GPS location 330a is the device network configuration 326 for the PV module controller 306 that provided the first GPS location 320a to the system network controller 310. In another example, the system network controller 310 may determine that the second GPS location 320b (X₂, Y₂) matches or is within a tolerance of the second planned GPS location 330b (X₂ₚ, Y_{2P}) of the second PV module controller 306b, and based on this correlation, the system network controller 310 may determine the device network configuration 326 for the second PV module controller 306b. In some embodiments, the tolerance for correlating the GPS location 320 to the planned GPS location 330 may be between about 0 feet and about 10 feet.

The system network controller 310 may associate the device identifiers of the PV module controllers 306 with the device network configuration 326 that the system network controller 310 determines to correspond with the PV module controllers 306 based on the GPS locations 320 of the PV module controllers 306. For example, the system network controller 310 may associate the device identifier (e.g., a MAC address) sent by the first PV module controller 306a with the device network configuration 326 (e.g., a network identifier and/or a node identifier) of the first PV module controller 306a.

The system network controller 310 may provide the PV module controllers 306 with the device network configuration 326 that the system network controller 310 determines to correspond with the PV module controllers 306 based on the GPS locations 320 of the PV module controllers 306. For example, the system network controller 310 may provide the device network configuration 326 associated with the first planned GPS location 330a to the first PV module controller 306a, and/or the system network controller 310 may provide the device network configuration 326 associated with the second planned GPS location 330b to the second PV module controller 306b.

In response to receiving the device network configuration 326, the PV module controllers 306 may establish a connection to a network. For example, the first PV module controller 306a may receive a device network configuration 326 and may establish a connection to a network and/or the second PV module controller 306b may receive another device network configuration 326 and may establish a connection to a network. In some embodiments, the network may be a network similar to the network 116 described with respect to FIG. 1. In some embodiments, the network may be a different network than the network 116 described with respect to FIG. 1. For example, the network may be a network of one or more system network controllers 310, one or more PV module controllers 306, and/or one or more weather controllers. In some embodiments, the PV module controller 306 may establish a connection with a wireless network such as a Zigbee network, a Bluetooth network, a Z-wave network, a Thread network, or other wireless networks depending on the device network configuration 326. For example, the one or more PV module controllers 306 may be connected to the system network controller 310 via a Zigbee network having a particular PAN identifier, and each of the one or more PV module controllers 306 may have a unique slave identifier in the Zigbee network that may allow the system network controller 310 to route data to specific PV module controllers 306. In some embodiments, the PV module controller 306 may establish a connection with a wired network such as a coaxial cable network, a fiber optic cable network, a category 5/5/e/6 network, an RS-485 (Modbus) network, an RS-232 network, or other wired networks, depending on the device network configuration 326. For example, one or more PV module controllers 306 may be connected to the system network controller 310 via an RS-485 network, and each of the one or more PV module controllers 306 may have a unique Modbus address that may allow the system network controller 310 to route data to specific PV module controllers 306.

Thus, the network configuration of each PV module controller 306 may be performed autonomously without sending a technician to the PV module controller 306 for configuration. In addition, the autonomous network configuration of the PV module controller 306 may reduce the time of the commissioning process and enable the PV system 300 to be operational days, weeks, or even months faster than the PV system 300 otherwise would be utilizing a manual process of network configuration.

Modifications, additions, or omissions may be made to the PV system 300 without departing from the scope of the present disclosure. For example, in some embodiments, any of the gateways 328 may be omitted. In some embodiments, the system network configuration 324 may be stored in the system network controller 310. In some embodiments, the device network configurations 326 and/or the planned GPS locations 330 may not be included in the system network configuration 324. In some embodiments, the device network configurations 326 and/or the planned GPS locations 330 may be provided and/or stored in the system network controller 310 separately from the system network configuration 324. Moreover, while multiple PV module controllers 306 are illustrated as being communicatively coupled with the system network controller 310, in some embodiments, a single PV module controller 306 may be communicatively coupled with the system network controller 310. Furthermore, in some embodiments, one or more weather controllers such as the weather controller 112 described with respect to FIG. 1 may be included in the PV system 300 and may be communicatively coupled to the system network controller 310 via the first gateway 328a and/or the second gateway 328b. In some embodiments, the PV module controller 306 may include an inclinometer such as the inclinometer 109 described with respect to FIG. 1. In these and other embodiments, the PV module controller 306 may automatically calibrate the inclination measured by the inclinometer with the inclination of a PV module. This is explained in further detail with reference to FIG. 5.

Additionally, as illustrated in FIGS. 4A and 4B, a PV system 400 configured to perform at least partially autonomous commissioning may include one or more PV module controllers 406 and multiple system network controllers 410. For instance, the PV system 400 may include a first system network controller 410a and a second system network controller 410b. The system network controller 410 may be similar to the system network controller 310 described with respect to FIG. 3. For example, the first system network controller 410a may be communicatively coupled with a first PV module controller 406a via a first gateway 428a, a second PV module controller 406b via a second gateway 428b, and/or one or more additional PV module controllers 406n via either or both of the gateways 428a and 428b, and the second system network controller 410b may be communicatively coupled with a third PV module controller 406c via a third gateway 428c, a fourth PV module controller 406d via a fourth gateway 428d, and one or more additional PV module controllers 406n via either or both of the gateways 428c and 428d.

The PV module controllers 406 may send a network configuration request including a device identifier and a GPS location 420 to the system network controllers 410. For example, the first PV module controller 406a may send a first network configuration request including a first GPS location 420a (X₁, Y₁) to the first system network controller 410a, the second PV module controller 406b may provide a second network configuration request including a second GPS location 420b (X₂, Y₂) to the first system network controller 410a, the third PV module controller 406c may provide a third network configuration request including a third GPS location 420c (X₃, Y₃) to the second system network controller 410b, the fourth PV module controller 406d may provide a fourth network configuration request including a fourth GPS location 420d (X₄, Y₄) to the second system network controller 410b, and/or the additional PV module controllers 406n may provide a GPS location 420n (Xₙ, Yₙ) to the system network controller 410.

Each of the system network controllers 410 may be provided with at least a portion of a system network configuration 424. The system network configuration 424 may include device network configurations 426 and/or planned GPS locations 430 for each of the PV module controllers 406. For example, the system network configuration 424 may include a first planned GPS location 430a (X_{1P}, Y_{1P}) for the first PV module controller 406a, a second planned GPS location 430b (X_{2P}, Y_{2P}) for the second PV module controller 406b, a third planned GPS location 430c (X_{3P}, Y_{3P}) for the third PV module controller 406c, a fourth planned GPS location 430d (X_{4P}, Y_{4P}) for the fourth PV module controller 406d, and/or a planned GPS location 430n (X_{nP}, Y_{nP}) for each of the additional PV module controllers 406n. In some embodiments, the first system network controller 410a may be provided device network configurations 426 and planned GPS locations 430 for those PV module controllers 406 that may be communicatively coupled with the first system network controller 410a, and/or the second system network controller 410b may be provided device network configurations 426 and planned GPS locations 430 for those PV module controllers 406 that may be communicatively coupled with the second system network controller 410b. In some embodiments, the system network controllers 410 may be provided with the entire system network configuration 424. In some embodiments, the system network controllers 410 may store at least a portion of the system network configuration 424.

As previously described with reference to FIG. 3, the system network controllers 410 may determine device network configurations 426 for the PV module controllers 406 based on the GPS locations 420 corresponding to the PV module controllers 406. For example, the system network controllers 410 may correlate the GPS locations 420 with the planned GPS locations 430 to determine which device network configuration 426 corresponds with each PV module controller 406. Additionally, as described with reference to FIG. 3, the system network controllers 410 may associate the device identifiers of the PV module controllers 406 with the device network configuration 426 that the system network controller 410 determines to correspond with the PV module controllers 406. Moreover, as described with reference to FIG. 3, the system network controller 410 may provide the PV module controllers 406 with the device network configuration 426 that the system network controller 410 determines to correspond with the PV module controllers 406 based on the GPS locations 420 of the PV module controllers 406. As previously described with reference to FIG. 3, in response to receiving the device network configuration 426, the PV module controllers 406 may establish a connection to a network.

The components illustrated in and described with reference to FIGS. 3, 4A, and 4B may be similar to, have similar features as, or perform similar functions as similarly named components described throughout this disclosure.

FIG. 5 illustrates an example PV system 500 configured to perform at least partially autonomous commissioning. The example PV system 500 may include a PV module controller 506. The PV module controller 506 may be coupled with a PV module 502 such that, as the PV module 502 rotates to track the position of the Sun, the PV module controller 506 may rotate with the PV module 502. For example, the PV module controller 506 may be coupled to a torque tube 505, which may be coupled to the PV module 502 via a clamp 504. The PV module 502 may be installed at a pre-determined inclination 503. For example, the PV module 502 may be installed at about zero degrees of inclination, which may be the pre-determined inclination 503.

The PV module controller 506 may include an inclinometer 509. The inclinometer 509 may be similar to the inclinometer 109 described with reference to FIG. 1. For example, the inclinometer 509 may be a digital inclinometer, a micro-electro-mechanical system (MEMS) inclinometer, a capacitive inclinometer, or any other inclinometer suitable for measuring the inclination of the PV module controller 506. In some embodiments, the inclinometer 509 may be included on a printed circuit board (PCB) of the PV module controller 506.

The inclinometer 509 may measure an inclination 507 of the PV module controller 506. In embodiments where the inclinometer 509 is included on the PCB of the PV module controller 506, the measured inclination 507 may be the inclination of the PCB within the PV module controller 506.

As illustrated in FIG. 5, the inclinometer 509 may not be perfectly aligned with the inclination of the PV module 502. For example, the clamp 504, the torque tube 505, and/or the PV module controller 506 may be slightly misaligned with the PV module 502 due to installation. As a result, the measured inclination 507 may be different than the inclination of the PV module 502. In these instances, without calibration, the inclination measured by the inclinometer 509 may not accurately represent the inclination of the PV module 502.

The PV module controller 506 may compare the inclination 507 measured by the inclinometer 509 with the pre-determined inclination 503 of the PV module 502. For example, the pre-determined inclination 503 of the PV module 502 may be 0 degrees and the measured inclination 507 of the PV module controller 506 may be non-zero, and the PV module controller 506 may determine that the pre-determined inclination 503 and the measured inclination 507 are different.

The PV module controller 506 may calibrate the measured inclination 507 of the PV module controller 506 to the pre-determined inclination 503 for the PV module 502. For example, the measured inclination 507 of the PV module controller 506 may be different than the pre-determined inclination 503 for the PV module 502, and the PV module controller 506 may calibrate the measured inclination 507 to the pre-determined inclination 503. For instance, the pre-determined inclination 503 may be zero degrees, the measured inclination 507 may be non-zero, and the PV module controller 506 may calibrate the measured inclination 507 of the inclinometer 509 to be zero such that the measured inclination 507 matches the pre-determined inclination 503 of the PV module 502. In some embodiments, the PV module controller 506 may calibrate the measured inclination 507 of the PV module controller 506 to the pre-determined inclination 503 of the PV module 502 in response to being powered on.

As a result, the PV module controller 506 may be commissioned autonomously without sending a technician to the PV module controller 506 to calibrate the inclinometer 509. In addition, the autonomous calibration of the inclinometer 509 may reduce the time of the commissioning process and enable the PV system 500 to be operational days, weeks, or even months faster than the PV system 500 otherwise would be utilizing a manual process of calibration.

Modifications, additions, or omissions may be made to the PV system 500 without departing from the scope of the present disclosure. For example, in some embodiments, the clamps 504 may be omitted. Additionally, in some embodiments, the PV module controller 506 may include a GPS such as the GPSs described throughout this disclosure. In these and other embodiments, the PV module controller 506 may automatically configure the PV module controller 506 to connect to a network. This is explained in further detail with reference to FIGS. 1-4B.

Furthermore, the components illustrated in FIG. 5 and described with reference to FIG. 5 may be similar to, have similar features as, or perform similar functions as similarly named components described throughout this disclosure. For example, the PV module controller 506 may be similar to the PV module controllers and/or the system network controllers may be similar to the system network controllers described throughout this disclosure.

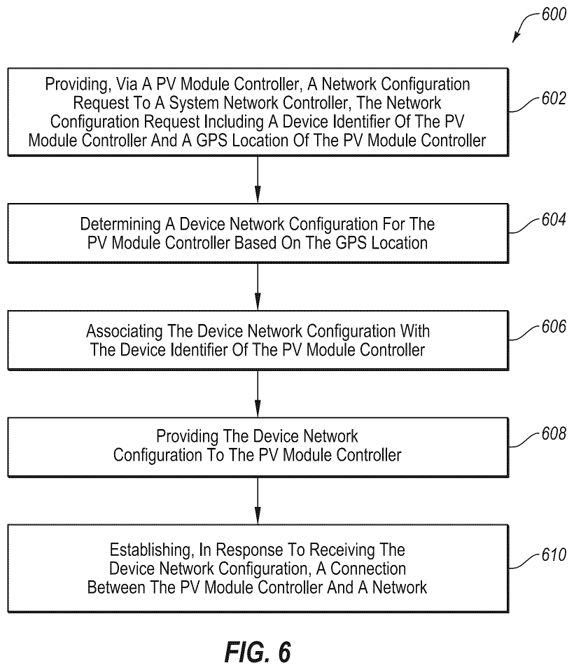

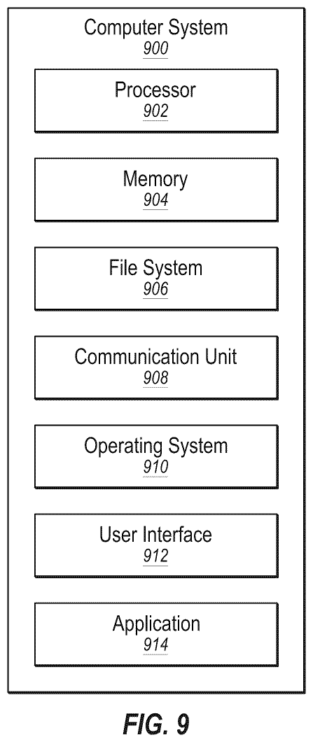

FIG. 6 illustrates a flowchart of an example method 600 of commissioning a PV system, in accordance with one or more embodiments of the present disclosure. The method 600 may be performed by any suitable system or device. For example, the method 600 may be at least partially implemented using the PV systems 100, 300, 400, and/or 500 described with respect to FIG. 1 and FIGS. 3-5 respectively and/or using the computer system 900 of FIG. 9. The method 600 may be at least partially implemented using the operational workflow 200 described with respect to FIG. 2. Although illustrated with discrete blocks, the steps and operations associated with one or more blocks of the method 600 may be divided into additional blocks, combined into fewer blocks, or eliminated, depending on the particular implementation.

The method 600 may include, at block 602, providing via a PV module controller, a network configuration request to a system network controller. The network configuration request may include a device identifier of the PV module controller and a GPS location of the PV module controller. In some embodiments, the device identifier may be a hardware identifier such as a media access control (MAC) address. The PV module controller and the system network controller may be similar to, have similar features as, or perform similar functions as similarly named components described throughout this disclosure. For example, as illustrated in FIG. 2, the PV module controller 206 may provide a network configuration request 218 including a GPS location 220 and a device identifier 222 to the system network controller 210.

The method 600 may include, at block 604, determining a device network configuration for the PV module controller based on the GPS location. For example, as illustrated in FIG. 2, the system network controller 210 may determine a device network configuration 226 for the PV module controller 206 based on the GPS location 220.

In some embodiments, the device network configuration may include at least one of a network identifier or a node identifier. In these and other embodiments, at least one of the network identifier or the node identifier may be associated with a planned GPS location of the PV module controller.

In some embodiments, the method 600 may further include correlating the GPS location of the PV module controller with the planned GPS location of the PV module controller. In these and other embodiments, the planned GPS location may be included in a system network configuration, and the determination of the device network configuration may be based on the correlation of the GPS location with the planned GPS location. For example, as illustrated in FIG. 3, the system network controller 310 may correlate the GPS location 320 of a PV module controller 306 with a planned GPS location 330 of the PV module controller 306, and the device network configuration 326 for the PV module controller 306 may be determined based on the correlation between the GPS location 320 and the planned GPS location 330 of the PV module controller 306. In some embodiments, the system network configuration may include the device network configuration. In some embodiments, the system network configuration may be stored in the system network controller.

The method 600 may include, at block 606, associating the device network configuration with the device identifier of the PV module controller. For example, as illustrated in FIG. 2, the device identifier 222 may be associated with the device network configuration 226 of the PV module controller 206.

The method 600 may include, at block 608, providing the device network configuration to the PV module controller. For example, as illustrated in FIG. 2, the system network controller 210 may provide the PV module controller 206 with the device network configuration 226.

The method 600 may include, at block 610, establishing a connection between the PV module controller and a network in response to receiving the device network configuration. For example, as illustrated in FIG. 3, the PV module controller(s) 306 may establish a connection to a network including the system network controller 310 and/or one or more additional PV module controllers 306n in response to receiving the device network configuration 326.

Modifications, additions, or omissions may be made to the method 600 without departing from the scope of the disclosure. For example, the designations of different elements in the manner described is meant to help explain concepts described herein and is not limiting. Further, the method 600 may include any number of other elements or may be implemented within other systems or contexts than those described.

For example, in some embodiments, the method 600 may include powering on the PV module controller, and the PV module controller may provide the network configuration request to the system network controller in response to being powered on. In another example, the blocks described in connection with the example method 700 may be performed as additional blocks in the example method 600.

Furthermore, the components described in the example method 600 may have similar features as, or perform similar functions as similarly named components described throughout this disclosure. For example, the PV module controller may be similar to the PV module controllers described throughout this disclosure and/or the system network controllers may be similar to the system network controllers described throughout this disclosure.

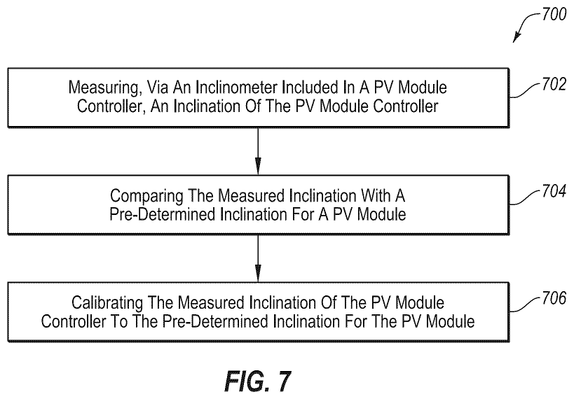

FIG. 7 illustrates a flowchart of an example method 700 of commissioning a PV system, in accordance with one or more embodiments of the present disclosure. The method 700 may be performed by any suitable system or device. For example, the method 700 may be at least partially implemented using the PV systems 100, 300, 400, and/or 500 described with respect to FIG. 1 and FIGS. 3-5 respectively and/or using the computer system 900 of FIG. 9. Although illustrated with discrete blocks, the steps and operations associated with one or more blocks of the method 700 may be divided into additional blocks, combined into fewer blocks, or eliminated, depending on the particular implementation.

The method 700 may include, at block 702, measuring, via an inclinometer included in a PV module controller, an inclination of the PV module controller. In some embodiments, the PV module controller may include a printed circuit board (PCB), and the measured inclination may be the inclination of the PCB. The PV module controller may be similar to the PV module controllers described throughout this disclosure. For example, as illustrated in FIG. 5, the PV module controller 506 may measure an inclination 507 via an inclinometer 509 included in the PV module controller 506.

The method 700 may include, at block 704, comparing the measured inclination with a pre-determined inclination for a PV module. The PV module may be similar to the PV modules described throughout this disclosure. For example, as illustrated in FIG. 5, the PV module 502 may have a pre-determined inclination 503, and the PV module controller 506 may compare the measured inclination 507 with the pre-determined inclination 503 for the PV module 502.

In some embodiments, the pre-determined inclination for the PV module may be about zero degrees. For example, as illustrated in FIG. 5, the pre-determined inclination 503 of the PV module 502 may be about zero degrees.

The method 700 may include, at block 706, calibrating the measured inclination of the PV module controller to the pre-determined inclination for the PV module. For example, as illustrated in FIG. 5, the PV module controller 506 may calibrate the measured inclination 507 of the PV module controller 506 to the pre-determined inclination 503 of the PV module 502.

Modifications, additions, or omissions may be made to the method 700 without departing from the scope of the disclosure. For example, the designations of different elements in the manner described is meant to help explain concepts described herein and is not limiting. Further, the method 700 may include any number of other elements or may be implemented within other systems or contexts than those described.

In some embodiments, the method 700 may further include powering on the PV module controller, and the PV module controller may calibrate the measured inclination of the PV module controller to the pre-determined inclination for the PV module in response to being powered on. For example, as illustrated in FIG. 5, the PV module controller 506 may be powered on, and the PV module controller 506 may calibrate the measured inclination 507 of the PV module controller 506 to the pre-determined inclination 503 for the PV module 502 in response to being powered on. In another example, the blocks described in connection with the example method 600 may be performed as additional blocks in the example method 700.

Furthermore, the components described in the example method 700 may have similar features as, or perform similar functions as similarly named components described throughout this disclosure. For example, the PV module controller may be similar to the PV module controllers described throughout this disclosure and/or the system network controllers may be similar to the system network controllers described throughout this disclosure.

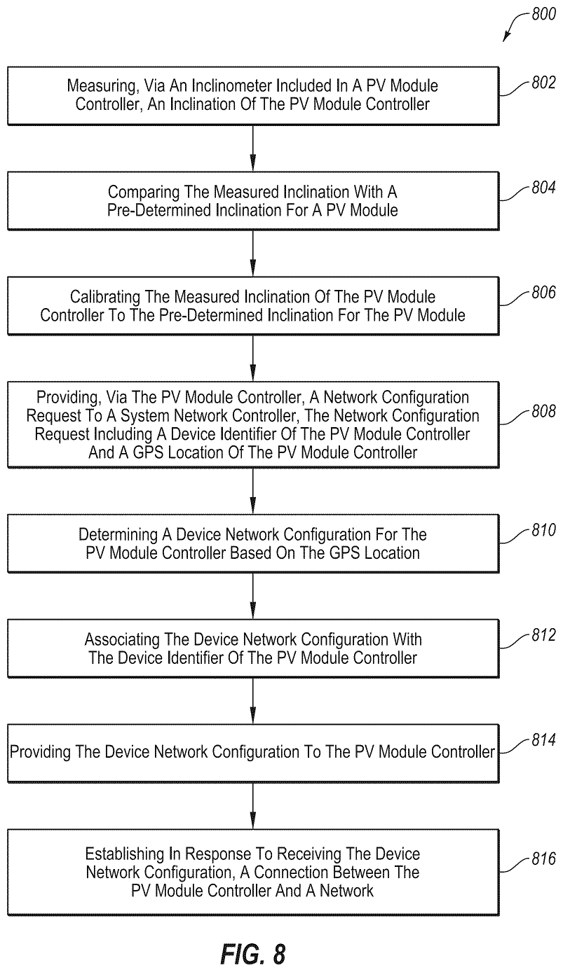

FIG. 8 illustrates a flowchart of an example method 800 of commissioning a PV system, in accordance with one or more embodiments of the present disclosure. The method 800 may be performed by any suitable system or device. For example, the method 800 may be at least partially implemented using the PV systems 100, 300, 400, and/or 500 described with respect to FIG. 1 and FIGS. 3-5 and/or using the computer system 900 of FIG. 9. The method 800 may be at least partially implemented using the operational workflow 200 described with respect to FIG. 2. Although illustrated with discrete blocks, the steps and operations associated with one or more blocks of the method 800 may be divided into additional blocks, combined into fewer blocks, or eliminated, depending on the particular implementation.

The method 800 may include, at block 802, measuring, via an inclinometer included in a PV module controller, an inclination of the PV module controller. In some embodiments, the PV module controller may include a printed circuit board (PCB), and the measured inclination may be the inclination of the PCB. The PV module controller may be similar to the PV module controllers described throughout this disclosure. For example, as illustrated in FIG. 5, the PV module controller 506 may measure an inclination 507 via an inclinometer 509 included in the PV module controller 506.

The method 800 may include, at block 804, comparing the measured inclination with a pre-determined inclination for a PV module. The PV module may be similar to the PV modules described throughout this disclosure. For example, as illustrated in FIG. 5, the PV module 502 may have a pre-determined inclination 503, and the PV module controller 506 may compare the measured inclination 507 with the pre-determined inclination 503 of the PV module 502.

In some embodiments, the pre-determined inclination for the PV module may be about zero degrees. For example, as illustrated in FIG. 5, the pre-determined inclination 503 of the PV module 502 may be about zero degrees.

The method 800 may include, at block 806, calibrating the measured inclination of the PV module controller to the pre-determined inclination for the PV module. For example, as illustrated in FIG. 5, the PV module controller 506 may calibrate the measured inclination 507 of the PV module controller 506 to the pre-determined inclination 503 of the PV module 502.

The method 800 may include, at block 808, providing via a PV module controller, a network configuration request to a system network controller. The network configuration request may include a device identifier of the PV module controller and a GPS location of the PV module controller. In some embodiments, the device identifier may be a hardware identifier such as a media access control (MAC) address. The PV module controller and the system network controller may be similar to, have similar features as, or perform similar functions as similarly named components described throughout this disclosure. For example, as illustrated in FIG. 2, the PV module controller 206 may provide a network configuration request 218 including a GPS location 220 and a device identifier 222 to the system network controller 210.

The method 800 may include, at block 810, determining a device network configuration for the PV module controller based on the GPS location. For example, as illustrated in FIG. 2, the system network controller 210 may determine a device network configuration 226 for the PV module controller 206 based on the GPS location 220.

In some embodiments, the device network configuration may include at least one of a network identifier or a node identifier. In these and other embodiments, at least one of the network identifier or the node identifier may be associated with a planned GPS location of the PV module controller.

In some embodiments, the method 800 may further include correlating the GPS location of the PV module controller with a planned GPS location of the PV module controller. In these and other embodiments, the planned GPS location may be included in a system network configuration, and the determination of the device network configuration may be based on the correlation of the GPS location with the planned GPS location. For example, as illustrated in FIG. 3, the system network controller 310 may correlate the GPS location 320 of a PV module controller 306 with a planned GPS location 330 of the PV module controller 306, and the device network configuration 326 for the PV module controller 306 may be determined based on the correlation between the GPS location 320 and the planned GPS location 330 of the PV module controller 306. In some embodiments, the system network configuration may include the device network configuration. In some embodiments, the system network configuration may be stored in the system network controller.

The method 800 may include, at block 812, associating the device network configuration with the device identifier of the PV module controller. For example, as illustrated in FIG. 2, the device identifier 222 may be associated with the device network configuration 226 of the PV module controller 206.

The method 800 may include, at block 814, providing the device network configuration to the PV module controller. For example, as illustrated in FIG. 2, the system network controller 210 may provide the PV module controller 206 with the device network configuration 226.

The method 800 may include, at block 816, establishing a connection between the PV module controller and a network in response to receiving the device network configuration. For example, as illustrated in FIG. 3, the PV module controller(s) 306 may establish a connection to a network including the system network controller 310 and/or one or more additional PV module controllers 306n in response to receiving the device network configuration 326.

Modifications, additions, or omissions may be made to the method 800 without departing from the scope of the disclosure. For example, the designations of different elements in the manner described is meant to help explain concepts described herein and is not limiting. Further, the method 800 may include any number of other elements or may be implemented within other systems or contexts than those described.

For example, in some embodiments, the method 800 may include powering on the PV module controller. In some embodiments, the PV module controller may provide the network configuration request to the system network controller in response to being powered on. In some embodiments, the PV module controller may calibrate the measured inclination of the PV module controller to the pre-determined inclination for the PV module in response to being powered on.

Furthermore, the components described in the example method 800 may have similar features as, or perform similar functions as similarly named components described throughout this disclosure. For example, the PV module controller may be similar to the PV module controllers described throughout this disclosure and/or the system network controllers may be similar to the system network controllers described throughout this disclosure.

FIG. 9 illustrates an example computer system 900 that may be employed in commissioning a PV system. In some embodiments, the computer system 900 may be part of any of the systems or devices described in this disclosure. For example, the computer system 900 may be part of any of the PV systems 100, 300, 400, or 500 described with respect to FIG. 1 and FIGS. 3-5, respectively, and/or the operational workflow 200 described with respect to FIG. 2. For example, the computer system 900 may be part of any of the system network controllers 110, 210, 310, or 410 of FIGS. 1-4, the PV module controllers 106, 206, 306, 406, or 506 of FIGS. 1-5, and/or the weather controller 112 of FIG. 1.

The computer system 900 may include a processor 902, a memory 904, a file system 906, a communication unit 908, an operating system 910, a user interface 912, and an application 914, which all may be communicatively coupled. In some embodiments, the computer system 900 may be, for example, a desktop computer, a client computer, a server computer, a mobile phone, a laptop computer, a smartphone, a smartwatch, a tablet computer, a portable music player, a networking device, or any other computer system.

Generally, the processor 902 may include any suitable special-purpose or general-purpose computer, computing entity, or processing device including various computer hardware or software applications and may be configured to execute instructions stored on any applicable computer-readable storage media. For example, the processor 902 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data, or any combination thereof. In some embodiments, the processor 902 may interpret and/or execute program instructions and/or process data stored in the memory 904 and/or the file system 906. In some embodiments, the processor 902 may fetch program instructions from the file system 906 and load the program instructions into the memory 904. After the program instructions are loaded into the memory 904, the processor 902 may execute the program instructions. In some embodiments, the instructions may include the processor 902 performing one or more of the actions of the methods disclosed herein.

The memory 904 and the file system 906 may include computer-readable storage media for carrying or having stored thereon computer-executable instructions or data structures. Such computer-readable storage media may be any available non-transitory media that may be accessed by a general-purpose or special-purpose computer, such as the processor 902. By way of example, and not limitation, such computer-readable storage media may include non-transitory computer-readable storage media including Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage media which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 902 to perform a certain operation or group of operations, such as one or more of the actions of the methods disclosed herein. These computer-executable instructions may be included, for example, in the operating system 910, in one or more applications, or in some combination thereof.

The communication unit 908 may include any component, device, system, or combination thereof configured to transmit or receive information over a network, such as, for example, the network 116 of FIG. 1 or the network 216 of FIG. 2. In some embodiments, the communication unit 908 may communicate with other devices at other locations, the same location, or even other components within the same system. For example, the communication unit 908 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, a cellular communication device, etc.), and/or the like. The communication unit 908 may permit data to be exchanged with a network and/or any other devices or systems, such as those described in the present disclosure.

The operating system 910 may be configured to manage hardware and software resources of the computer system 900 and configured to provide common services for the computer system 900.

The user interface 912 may include any device configured to allow a user to interface with the computer system 900. For example, the user interface 912 may include a display, such as an LCD, LED, or other display, that is configured to present video, text, application user interfaces, and other data as directed by the processor 902. The user interface 912 may further include a mouse, a track pad, a keyboard, a touchscreen, volume controls, other buttons, a speaker, a microphone, a camera, any peripheral device, or other input or output device. The user interface 912 may receive input from a user and provide the input to the processor 902. Similarly, the user interface 912 may present output to a user.

The application 914 may be one or more computer-readable instructions stored on one or more non-transitory computer-readable media, such as the memory 904 or the file system 906, that, when executed by the processor 902, is configured to perform one or more of the actions of the methods disclosed herein. In some embodiments, the application 914 may be part of the operating system 910 or may be part of an application of the computer system 900, or may be some combination thereof.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of commissioning a photovoltaic (PV) system, the method comprising:
providing, via a PV module controller, a network configuration request to a system network controller, the network configuration request including a device identifier of the PV module controller and a GPS location of the PV module controller;
determining a device network configuration for the PV module controller based on the GPS location of the PV module controller;
associating the device network configuration with the device identifier of the PV module controller;
providing the device network configuration to the PV module controller; and
establishing, in response to receiving the device network configuration, a connection between the PV module controller and a network.

2. The method of claim 1, further comprising:
correlating the GPS location of the PV module controller with a planned GPS location of the PV module controller, the planned GPS location being included in a system network configuration; and
wherein the determination of the device network configuration is based on the correlation of the GPS location with the planned GPS location.

3. The method of claim 2, wherein the system network configuration is stored in the system network controller.

4. The method of claim 2, wherein the system network configuration includes the device network configuration.

5. The method of claim 1, further comprising:
powering on the PV module controller;
wherein, the PV module controller provides the network configuration request to the system network controller in response to being powered on.

6. The method of claim 1, wherein the device identifier is a media access control (MAC) address.

7. The method of claim 1, wherein the device network configuration includes at least one of a network identifier or a node identifier, at least one of the network identifier or the node identifier being associated with a planned GPS location of the PV module controller.

8. A method of commissioning a photovoltaic (PV) system, the method comprising:
measuring, via an inclinometer included in a PV module controller, an inclination of the PV module controller;
comparing the measured inclination with a pre-determined inclination of a PV module; and
calibrating the measured inclination of the PV module controller to the pre-determined inclination of the PV module.

9. The method of claim 8, wherein the pre-determined inclination of the PV module is about zero degrees.

10. The method of claim 8, further comprising:
powering on the PV module controller;
wherein, the PV module controller calibrates the measured inclination of the PV module controller to the pre-determined inclination of the PV module in response to being powered on.

11. The method of claim 8, wherein the PV module controller includes a printed circuit board (PCB), and the measured inclination is the inclination of the PCB.

12. A method of commissioning a photovoltaic (PV) system, the method comprising:
measuring, via an inclinometer included in a PV module controller, an inclination of the PV module controller;
comparing the measured inclination with a pre-determined inclination of a PV module;
calibrating the measured inclination of the PV module controller to the pre-determined inclination of the PV module;
providing, via the PV module controller, a network configuration request to a system network controller, the network configuration request including a device identifier of the PV module controller and a GPS location of the PV module controller;
determining a device network configuration for the PV module controller based on the GPS location;
associating the device network configuration with the device identifier of the PV module controller;
providing the device network configuration to the PV module controller; and
establishing, in response to receiving the device network configuration, a connection between the PV module controller and a network.

13. The method of claim 12, further comprising:
correlating the GPS location of the PV module controller with a planned GPS location of the PV module controller, the planned GPS location being included in a system network configuration;
wherein the determination of the device network configuration is based on the correlation of the GPS location with the planned GPS location.

14. The method of claim 13, wherein the system network configuration is stored in the system network controller.

15. The method of claim 13, wherein the system network configuration includes the device network configuration.

16. The method of claim 12, further comprising:
powering on the PV module controller;
wherein, the PV module controller provides the network configuration request to the system network controller in response to being powered on; and
wherein, the PV module controller calibrates the measured inclination of the PV module controller to the pre-determined inclination of the PV module in response to being powered on.

17. The method of claim 12, wherein the device identifier is a media access control (MAC) address.

18. The method of claim 12, wherein the device network configuration includes at least one of a network identifier or a node identifier, at least one of the network identifier or the node identifier being associated with a planned GPS location of the PV module controller.

19. The method of claim 12, wherein the pre-determined inclination of the PV module is about zero degrees.

20. The method of claim 12, wherein the PV module controller includes a printed circuit board (PCB), and the measured inclination is the inclination of the PCB.
